(19) United States
(12) Patent Application Publication
(10) Pub. No.: US 2026/0302593 A1
(43) Pub. Date: Oct. 1, 2026

(54) MILLIMETER-WAVE ANTENNA

(71) Applicant: TEXAS INSTRUMENTS INCORPORATED, DALLAS, TX (US)

(72) Inventors: Mohammad Varnoosfaderani Varnoosfaderani, Dallas, TX (US); Thomas Kronenberg, Dallas, TX (US); Harshpreet Bakshi, Dallas, TX (US); Rajen Manicon Murugan, Dallas, TX (US)

(21) Appl. No.: 19/095,230

(22) Filed: Mar. 31, 2025

(51) Int. Cl. H01Q 1/22; H01L 23/498; H01Q 1/52; H01Q 9/28

(52) U.S. Cl. CPC H01Q 1/2283; H01Q 1/526; H01Q 9/285; H10W 70/65

(57) ABSTRACT

A semiconductor package includes a flat no-leads interconnect and a dipole antenna formed from a ground plane of the flat no-leads interconnect. The semiconductor package also includes a plurality of wire bonds surrounding the dipole antenna to form an RF (radio frequency) shielding cavity and a mold compound encapsulating the dipole antenna, the wire bonds and a portion of the flat no-leads interconnect.

### TECHNICAL FIELD

This description relates to a millimeter-wave antenna integrated on a semiconductor package.

### BACKGROUND

Millimeter-wave radar sensors are widely used in industrial and consumer electronics applications. The manufacturing process for FCCSP (flip-chip chip scale packages) and PoP (package-on-package) technologies has been used for implementing planar antennas such as patch and slot antennas in these radar devices. These radar sensors typically utilize antenna-on-package technology, implementing antennas using flip chip package technology. The flip chip packaging approach allows for planar antenna structures that provide ease of manufacturing, as the antenna designs can be directly transferred from PCB to package implementations.

QFN (quad-flat no-leads) packages are surface-mount integrated circuit packages that utilize a lead frame structure with a ground plane surrounded by peripheral leads. The QFN package incorporates an interconnect (e.g., a metal lead frame) that provides electrical connections between a semiconductor die and external circuitry, with the die mounted on the ground plane. A mold compound encapsulates the die, wire bonds and portions of the interconnect while leaving the bottom surface of the leads exposed for electrical contact.

### SUMMARY

A first example relates to a semiconductor package including a flat no-leads interconnect and a dipole antenna formed from a ground plane of the flat no-leads interconnect. The semiconductor package also includes a plurality of wire bonds surrounding the dipole antenna to form an RF (radio frequency) shielding cavity and a mold compound encapsulating the dipole antenna, the wire bonds and a portion of the flat no-leads interconnect.

A second example relates to a millimeter-wave device that includes a flat no-leads semiconductor package. The flat no-leads package includes an interconnect having leads and a ground plane and a semiconductor die mounted on the ground plane of the interconnect. The flat no-leads package also includes a dipole antenna formed from the ground plane of the interconnect and electrically connected to the semiconductor die and a plurality of wire bonds circumscribing the dipole antenna to form an RF shielding cavity. The flat no-lead packaging further includes a mold compound encapsulating the dipole antenna, the die and a portion of the interconnect. The millimeter-wave device also includes a PCB (printed circuit board) with an AMC (artificial magnetic conductor) structure positioned below the dipole antenna.

A third example relates to a method of fabricating a semiconductor package, including mounting a semiconductor die on a ground plane of a flat no-leads interconnect. The method also includes forming a dipole antenna from the ground plane of the flat no-leads interconnect and placing wire bonds circumscribing the dipole antenna to create a cavity for shielding the dipole antenna. The method further includes encapsulating the semiconductor die, the dipole antenna, the wire bonds and a portion of the interconnect in a mold compound.

### BRIEF DESCRIPTION OF THE DRAWINGS

FIG. 1A illustrates a millimeter-wave device (e.g., a circuit) implemented with a QFN (quad-flat no-leads) package mounded on a PCB (printed circuit board).

FIG. 1B shows a cross-sectional view of the millimeter-wave device taken along line A-A.

FIG. 2A illustrates a propagation path of an RF (radio frequency) wave communicated with a dipole antenna.

FIG. 2B illustrates a detailed view of the AMC.

FIG. 3 illustrates a millimeter-wave device that is employable to implement the millimeter-wave device of FIG. 1A.

FIG. 4 illustrates a millimeter-wave device that is employable to implement the millimeter-wave device of FIG. 1A.

FIG. 5A illustrates a magnetic field graph that plots a magnitude of a magnetic field as a function of an angle of the millimeter-wave device of FIG. 4.

FIG. 5B illustrates an electric field graph that plots a magnitude of an electric field as a function of an angle of the millimeter-wave device of FIG. 4.

FIG. 5C plots illustrates a graph that plots a return loss as a function of frequency.

FIG. 6 illustrates an example of a system employing a millimeter-wave device as a radar sensor.

FIG. 7 illustrates a flowchart of an example method for fabricating a semiconductor package, such as the QFN package of FIG. 1A.

### DETAILED DESCRIPTION

This description relates to a millimeter-wave device, such as a radar sensor implemented with flat no-leads packaging, such as DFN (dual-flat no-leads) or QFN (quad-flat no-leads). The flat no-leads packaging enables innovative antenna designs with RF shielding wire bonds to create cavity structures around individual antennas, providing superior isolation between adjacent antennas. This wire bond shielding approach allows antennas to be placed with half-wavelength spacing while maintaining proper radar array operation.

The flat no-leads packaging supports differential feeding of dipole antennas, avoiding the need for single-ended to differential conversion required with patch antenna designs. The dipole antennas of the semiconductor package achieve wide bandwidth operations while maintaining return loss better than −14 dB (decibels) across the 57-64 GHz (gigahertz) operating band.

The semiconductor package is mountable on an AMC (artificial magnetic conductor) structure implemented in the PCB beneath the QFN package. This enables tuned antenna radiation characteristics by providing nearly zero phase shift for reflected electromagnetic waves. This allows the dipole antennas to be placed closer than one-quarter wavelength from the AMC while maintaining proper radiation patterns. The flat no-leads semiconductor package with integrated dipole antennas can be manufactured using standard processes, with the antennas fabricated directly on an interconnect (e.g., a lead frame) and connected through inductive wire bonds to the die pads.

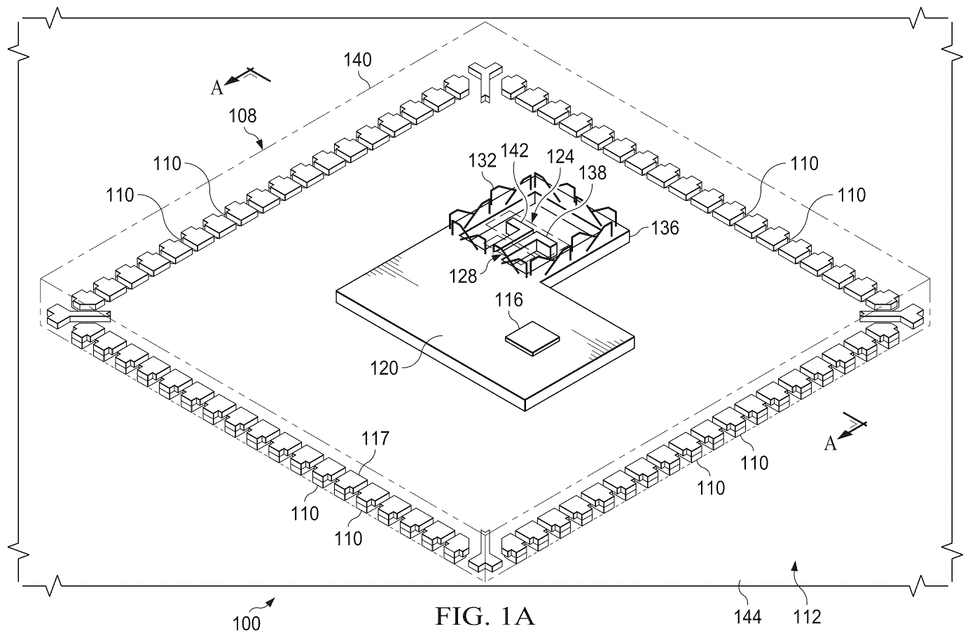

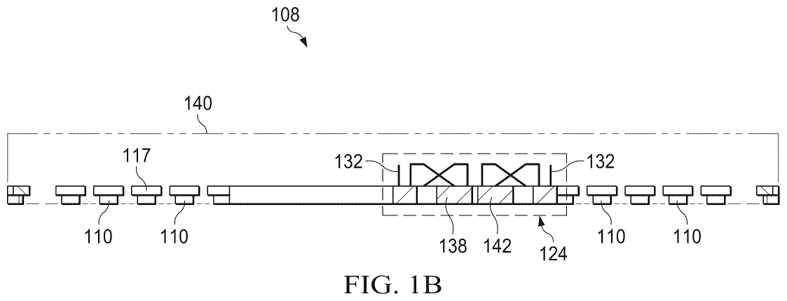

FIG. 1A illustrates an isometric view of a millimeter-wave device 100 (e.g., a circuit) implemented with a QFN (quad-flat no-leads) package 108 mounded on a PCB (printed circuit board) 112. FIG. 1B shows a cross-sectional view of the millimeter-wave device 100 taken along line A-A. The example illustrated in FIGS. 1A and 1B, employs the QFN architecture. In other examples, other flat no-leads architectures, such as DFN (dual-flat no-leads) architecture are employable.

The QFN package 108 includes a die 116 disposed on a ground plane 120 of an interconnect 117 (alternatively referred to a lead frame, and some portions of the interconnect 117 are shown as transparent). In some examples, the die 116 can be omitted. The QFN package 108 includes leads 110 (only some of which are labeled) that are formed along a periphery of the QFN package 108. The leads 110 enable the QFN package 108 to be electrically coupled to external electrical components.

A dipole antenna 124 is formed by modifying the ground plane 120 and the dipole antenna 124 is connected to the die 116 through metal routing structures 128, which can operate as one-quarter wavelength transmission lines in some examples. The dipole antenna 124 is surrounded by RF (radio frequency) shielding wire bonds 132 mounted on a metal trace 136 that forms a cavity structure to surround the dipole antenna 124 for improved isolation. The wire bonds 132 are arranged in a non-parallel manner, such as in an ‘X’ configuration (e.g., individual wire bonds 132 crisscross) to avoid unintentional polarization of propagating RF waves. The metal trace 136 is grounded (e.g., connected to a ground plane of the millimeter-wave device 100). The wire bonds 132 are arranged in a perimeter to circumscribe the dipole antenna 124 to form shielding walls.

The dipole antenna 124 is oriented horizontally, such that the elements of the dipole antenna 124 extend from a centerline toward the leads 110 at the periphery of the QFN package 108. The dipole antenna 124 includes a first element 138 and a second element 142. The metal trace 136 is wider than the first element 138 and the second element 142. The dipole antenna 124, the die 116, the wire bonds 132 and a portion of the interconnect 117 are encapsulated in a mold compound 140. The mold compound 140 is formed of plastic or a dielectric material that does not impede the propagation of RF waves.

The PCB 112 includes an AMC (artificial magnetic conductor) 144 positioned below the dipole antenna 124. The AMC 144 can alternatively be referred to as an AMC structure. The AMC 144 includes two layers of a periodic pattern of conductive elements separated by a dielectric layer. In some examples, the periodic conductive elements of the AMC are arranged in a checkerboard pattern to create the AMC properties needed for antenna operation. The dielectric layer separates the first and second layers of conductive elements. The AMC 144 enables the QFN package 108 to be mounted on the PCB 112, such that the dipole antenna 124 is closer to the AMC 144 and a bottom surface of the QFN package 108 than one-quarter wavelength of a center frequency of the dipole antenna 124 while maintaining radiation performance. Thus, the QFN package 108 can be sized smaller (e.g., less thick) than conventional IC packages with dipole antennas that are mounted on a ground plane.

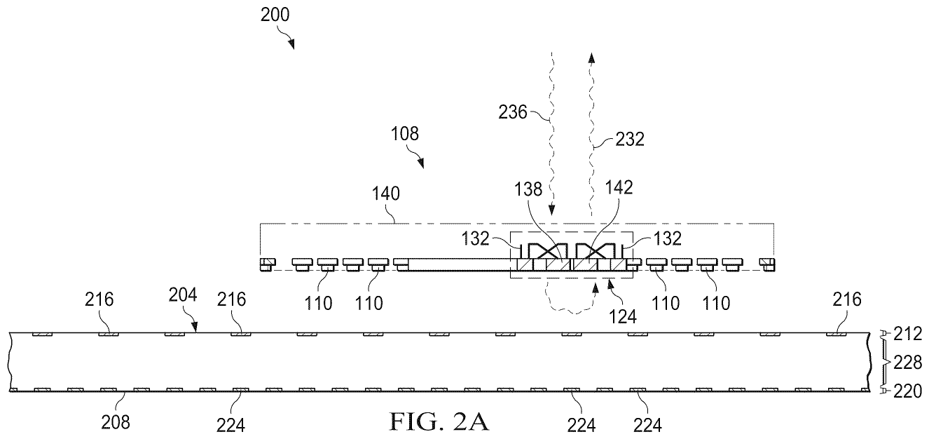

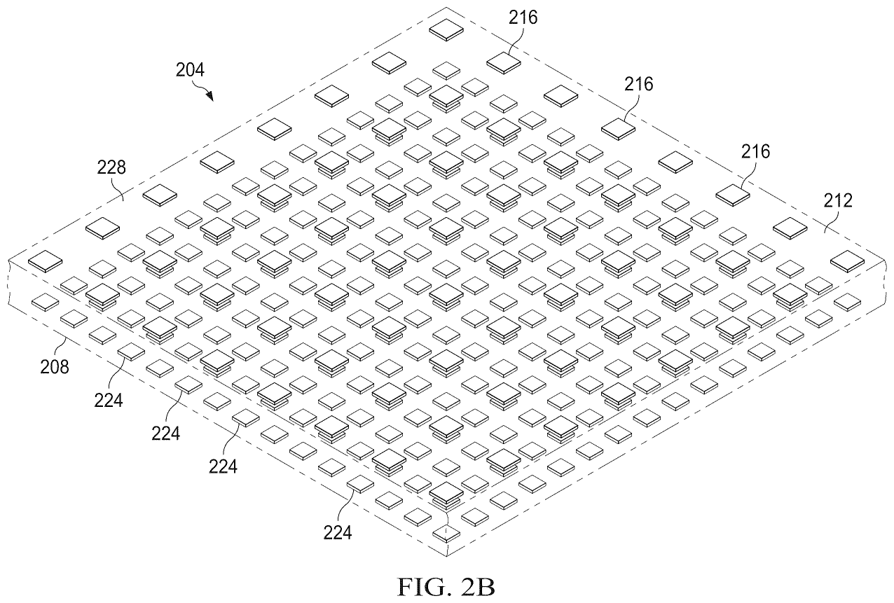

FIG. 2A illustrates a cross-sectional view of a millimeter-wave device 200 that includes the QFN package 108 of FIG. 1B mounted on a PCB 204 that includes an AMC 208. The millimeter-wave device 200 can be employed to implement the millimeter-wave device 100 of FIG. 1A.

The AMC 208 underlies the dipole antenna 124 of the QFN package 108. Stated differently, the QFN package 108 is mounted on the PCB 204 such that the AMC 208 (which can be a portion of the PCB 204) underlies the dipole antenna 124 embedded in the QFN package 108.

The AMC 208 includes a first layer 212 (e.g., a top layer) of a first periodic pattern of metal elements 216 (only some of which are labeled). The AMC 208 also includes a second layer 220 with a second periodic pattern of metal elements 224 (only some of which are labeled). The AMC 208 includes a dielectric layer 228 formed of a dielectric material disposed around and between the first layer 212 and the second layer 220 of the AMC 208. As one example, the millimeter-wave device 100 has a bandwidth over a frequency band ranging from about 57 GHz to about 64 GHz. In other examples, the dipole antenna 124 of the QFN package 108 can have a bandwidth across a different frequency band.

FIG. 2B illustrates a detailed view of the AMC 208. As illustrated in a combination of FIG. 2A and FIG. 2B, the first layer 212 has a checkerboard pattern of the metal elements 216 (the first periodic pattern). Similarly, the second layer 220 also has a checkerboard pattern of the metal elements 224 (the second periodic pattern). In the example illustrated, there are more metal elements 224 in the second layer 220 than metal elements 216 in the first layer 212. The AMC 208 is designed such that RF waves are reflected by the AMC 208 with nearly zero phase shift.

In FIG. 2A, the QFN package 108 is spaced apart from the AMC 208 for illustrative purposes. However, in operation, the QFN package 108 is mounted directly on the AMC 208 of the PCB 204. FIG. 2A illustrates a propagation path of an RF wave transmitted by the dipole antenna 124. A first RF wave 232 radiates from the first element 138 in a direction normal to a top surface of the AMC 208. A second RF wave 236 can be transmitted in an opposite direction that is normal to the top surface of the AMC 208, and this second RF wave 236 can be reflected by the AMC 208 toward the first RF wave 232 with nearly zero phase shift. Accordingly, the first RF wave 232 and the second RF wave 236 can constructively interfere, increasing a gain of the dipole antenna 124. As one example, the millimeter-wave device 200 has a bandwidth over a frequency band ranging from about 57 GHz (gigahertz) to about 64 GHz. In other examples, the dipole antenna 124 of the millimeter-wave device 200 can have a bandwidth across a different frequency band.

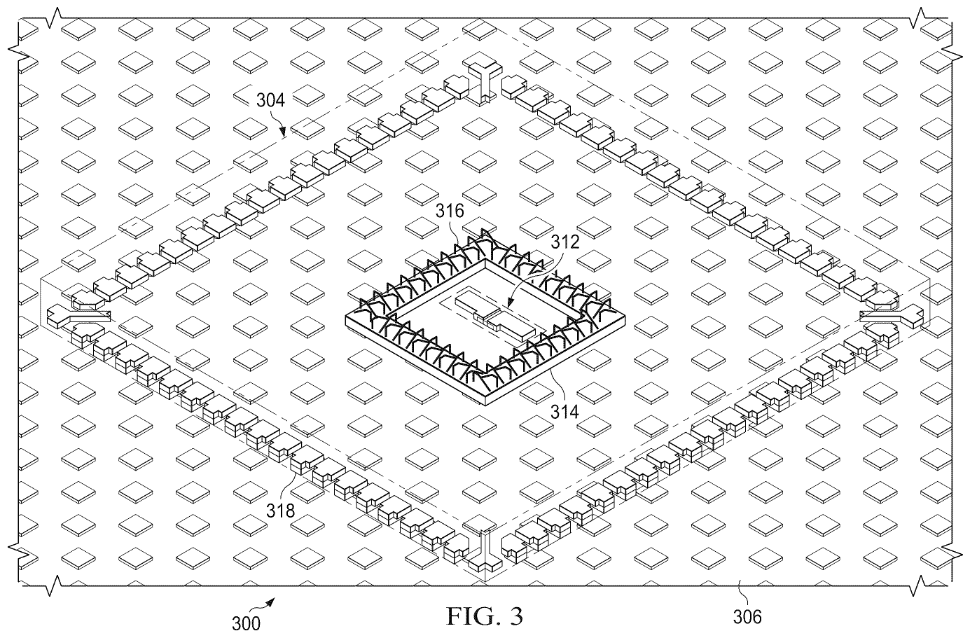

FIG. 3 illustrates a millimeter-wave device 300 that is employable to implement the millimeter-wave device 100 of FIG. 1A. The millimeter-wave device 300 includes a QFN package 304 (e.g., a semiconductor package) mounted on an AMC 306 of a PCB. The QFN package 304 includes a ground plane (transparent in FIG. 3) on which a die could be mounted centrally located within the QFN package 304. The QFN package 304 includes a single dipole antenna 312 formed from modifying the ground plane. In some examples, wire bonds can be coupled to other components of the QFN package 304 to drive the dipole antenna 312.

The dipole antenna 312 is surrounded by a metal trace 314, and RF shielding wire bonds 316 (only some of which are labeled) are coupled to the metal trace 314 to create a cavity structure around the antenna. The RF shielding wire bonds 316 are arranged in an X-shaped crossing pattern (or other arrangement) and are coupled to the metal trace 314, which is in-turned coupled to a ground plane. The X-shaped pattern provides manufacturing advantages by avoiding multiple parallel wire bonds which could cause tighter manufacturing tolerances and/or change propagation of an RF wave communicated with the dipole antenna 312. Moreover, in the example illustrated, the metal trace 314 and the RF shielding wire bonds 316 surround the dipole antenna 312 on four sides to improve isolation of the dipole antenna 312.

The QFN package 304 includes leads 318 (only one of which is labeled) at a periphery of the QFN package 304. In some examples, the dipole antenna 312 can be coupled to the leads 318 with wire bonds or routed conductive traces (not shown). The dipole antenna 312 is connected to a die (or other antenna driver) through a quarter wavelength (of a center frequency of the dipole antenna 312) twin line transmission line to enable proper antenna operation. As one example, the millimeter-wave device 300 operates in the 57-64 GHz frequency range for radar applications, achieving return loss better than −14 dB across the operating band, which corresponds to less than 1% power reflection.

The AMC 306 is implemented in the PCB such that the AMC 306 is positioned below the dipole antenna 312 of the QFN package 304. The AMC 306 enables placement of the dipole antenna close to the AMC 306 (e.g., less than a quarter-wavelength of a center frequency of the dipole antenna 312) while maintaining radiation pattern stability and wide bandwidth operation. The AMC 306 comprises two layers of periodic metal elements (e.g., in checkerboard patterns) separated by a dielectric in the PCB to create artificial magnetic conductor properties, allowing the dipole antenna 312 to be placed closer than a quarter wavelength from the AMC 306 while maintaining proper operation.

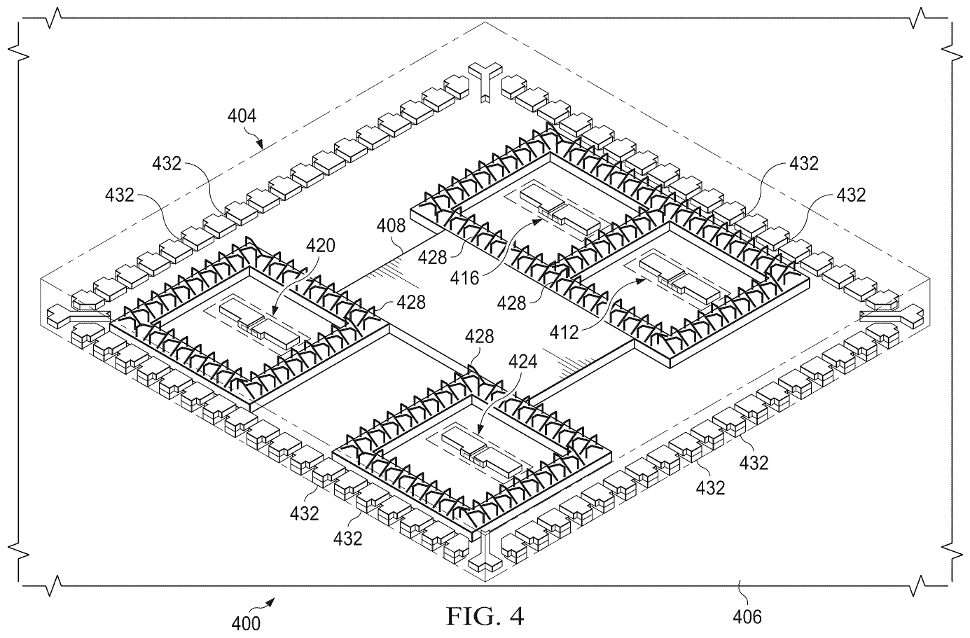

FIG. 4 illustrates a millimeter-wave device 400 that is employable to implement the millimeter-wave device 100 of FIG. 1A. The millimeter-wave device 400 includes a QFN package 404 (a semiconductor package, more generally) mounted on an AMC 406 of a PCB. The QFN package 404 has ground plane 408 (on which a die can be mounted) centrally located within the QFN package 404. The QFN package 404 includes a set of dipole antennas. The set of dipole antennas includes four dipole antennas, namely a first dipole antenna 412, a second dipole antenna 416, a third dipole antenna 420 and a fourth dipole antenna 424 that are arranged in a 2T2R (two-transmitter, two-receiver) configuration.

The dipole antennas 412-424 are arranged around the ground plane 408 with at least half-wavelength spacing between adjacent antennas to enable proper radar array operation while maintaining isolation. Each of the dipole antennas 412-424 is surrounded by RF shielding wire bonds 428 arranged in an X-shaped crossing pattern (or other pattern) and coupled to a ground plane to provide isolation between adjacent antennas. The X-shaped wire bonds 428 arrangement avoids multiple parallel wire bonds that could interfere with wave propagation. The first dipole antenna 412 and the second dipole antenna 416 (adjacent dipole antennas) are spaced by approximately one-half of a wavelength of the center frequency of the first dipole antenna 412 and the second dipole antenna 416. Similarly, the third dipole antenna 420 and the fourth dipole antenna 424 (adjacent dipole antennas) are spaced apart by more than one-half wavelength of the center frequency of the third dipole antenna 420 and the fourth dipole antenna 424.

The dipole antennas 412-424 are fabricated as part of the QFN package manufacturing process and include wire bond connections to the leads 432 (only some of which are labeled) of the QFN package 404 or to a die (not shown) of the QFN package 404. The dipole antennas 412-424 are driven through quarter wavelength twin line transmission lines to enable proper antenna operation. In some examples, the millimeter-wave device 400 operates in the 57-64 GHz frequency range for radar applications, achieving return loss better than −14 dB across the operating band.

The 2T2R configuration enables implementation of a virtual array for FMCW (frequency modulation continuous wave) radar applications, where the two transmitter antennas work in conjunction with the two receiver antennas to create an expanded virtual array. This arrangement provides improved radar performance while maintaining the cost advantages of the QFN package implementation.

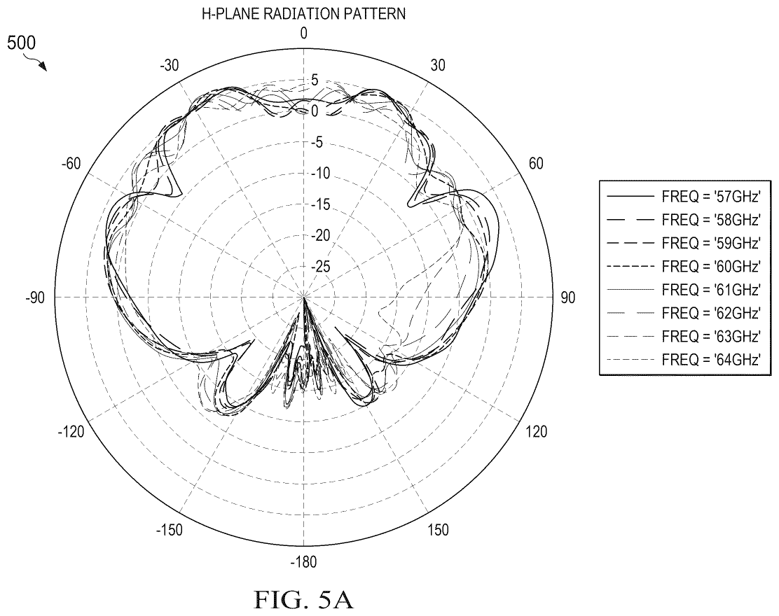

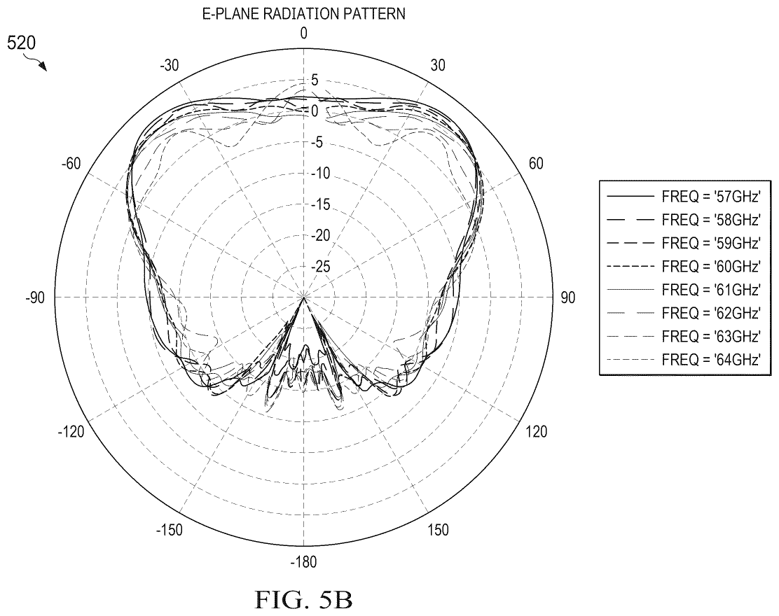

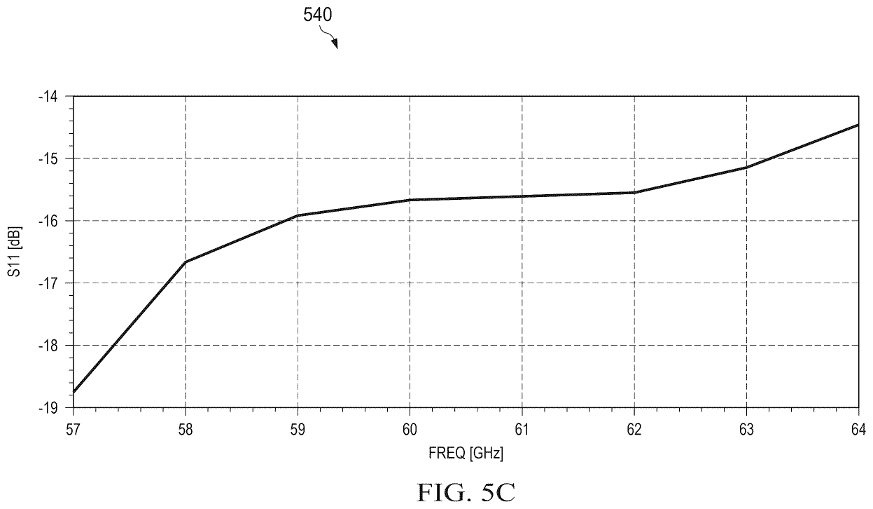

FIGS. 5A-5C illustrate operational characteristics of the millimeter-wave device 400 of FIG. 4. In particular, FIG. 5A illustrates a magnetic field graph 500 that plots a magnitude of a magnetic field as a function of angle (in degrees) of the millimeter-wave device 400 of FIG. 4 for a frequency range of 57 GHz to 64 GHz. FIG. 5B illustrates an electric field graph 520 that plots a magnitude of an electric field as a function of angle (in degrees) of the millimeter-wave device 400 of FIG. 4 for a frequency range of 57 GHz to 64 GHz. Together FIGS. 5A and 5B plot the radiation pattern of the millimeter-wave device 400. FIG. 5C plots illustrates a graph 540 that plots a return loss (S11) in decibels (dB) as a function of frequency (in GHz). As is illustrated, in the frequency range of 57-64 GHz, the millimeter-wave device 400 maintains a return loss better than −14 dB.

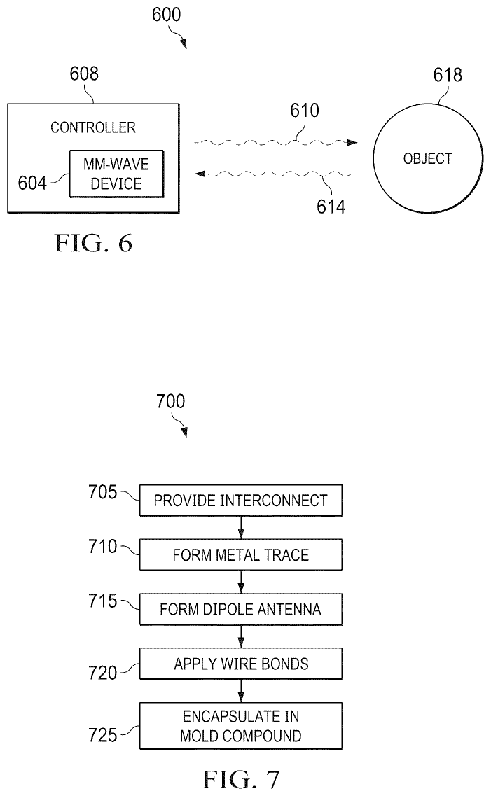

FIG. 6 illustrates an example of a system 600 employing a millimeter-wave device 604 as a radar sensor. The millimeter-wave device 604 could be implemented by the millimeter-wave device 100 of FIG. 1A, the millimeter-wave device 300 of FIG. 3 or the millimeter-wave device 400 of FIG. 4. The millimeter-wave device 604 can be coupled to and/or integrated with a controller 608, such as a microcontroller.

The controller 608 is configured to control transmission of RF waves 610 from the millimeter-wave device 604 and measure frequency shifts in reflected RF waves 614 to determine a distance and/or presence of an object 618. The RF waves 610 operate in a frequency range between 57 GHz and 64 GHz for radar applications.

The system 600 is employable in various applications including smart home devices (e.g., automated lighting), automated entrances, industrial robots and level sensors. The low-cost QFN package implementation of the millimeter-wave device 604 with integrated dipole antennas enables cost-effective radar sensing capabilities for nearly any application that can leverage millimeter wave radar technology.

The millimeter-wave device 604 achieves high radar performance through inclusion of an AMC that enables proper antenna radiation characteristics and the RF shielding wire bonds that provide isolation between multiple antennas in multi-antenna configurations. The system 600 leverages the cost advantages of QFN packaging while maintaining high performance radar sensing capabilities.

FIG. 7 illustrates a flowchart of an example method 700 for fabricating a semiconductor package, such as the QFN package 108 of FIG. 1A. The semiconductor package includes an integrated dipole antenna (or multiple dipole antennas). At block 705, an interconnect (e.g., a lead frame) is provided having a ground plane on which a die can be mounted and peripheral leads. The lead frame is configured to implement flat no-leads package architecture, such as a DFN package architecture or QFN package architecture.

At block 710, a metal trace is formed circumscribing a region adjacent to the ground plane where a dipole antenna will be formed. The metal trace can be coupled to a ground plane of the interconnect. At block 715, a dipole antenna is formed within the circumscribed region, where the dipole antenna includes first and second elements extending horizontally from a centerline. The metal trace is wider than elements of the dipole antenna elements.

At block 720, RF shielding wire bonds are attached to the metal trace in an X-shaped crossing pattern (or other non-parallel pattern) to create a cavity structure surrounding the dipole antenna. The X-shaped arrangement avoids multiple parallel wire bonds which could impact wave propagation. The wire bonds are coupled to the ground plane through the metal trace to provide RF shielding and isolation for the dipole antenna. At block 725, a mold compound is formed to encapsulate the dipole antenna, the wire bonds, and a portion of the interconnect. The resultant semiconductor package can be placed on an AMC of a PCB (e.g., the AMC 144 of FIG. 1A) to form a millimeter wave device. In the resultant semiconductor package, the dipole antenna is spaced from the AMC (and a bottom surface of the semiconductor package) by less than one-quarter of a wavelength of a center frequency of the dipole antenna.

In this description, unless otherwise stated, “about” or “approximately” preceding a parameter means being within +/−10 percent of that parameter. Further, in this description, the term “couple”, “coupled” or “couples” means either an indirect or direct connection. Modifications are possible in the described embodiments, and other embodiments are possible, within the scope of the claims.

What is claimed is:

1. A semiconductor package comprising:
a flat no-leads interconnect;
a dipole antenna formed from a ground plane of the flat no-leads interconnect;
a plurality of wire bonds surrounding the dipole antenna to form an RF (radio frequency) shielding cavity; and
a mold compound encapsulating the dipole antenna, the wire bonds and a portion of the flat no-leads interconnect.

2. The semiconductor package of claim 1, further comprising a die disposed on the ground plane of the flat no-leads interconnect, wherein the die is electrically coupled to the dipole antenna.

3. The semiconductor package of claim 1, wherein the flat no-leads interconnect is a QFN (quad-flat no-leads) interconnect.

4. The semiconductor package of claim 1, wherein the dipole antenna is spaced from a bottom surface of the semiconductor package by less than one-quarter of a wavelength of a center frequency of the dipole antenna.

5. The semiconductor package of claim 1, wherein the dipole antenna comprises a set of dipole antennas arranged in a two-transmitter, two-receiver configuration.

6. The semiconductor package of claim 5, wherein the RF shielding cavity formed by the wire bonds provides isolation between adjacent dipole antennas of the set of dipole antennas.

7. The semiconductor package of claim 1, wherein the semiconductor package is configured for mounting on an AMC (artificial magnetic conductor) structure of a PCB (printed circuit board) disposed beneath the dipole antenna.

8. The semiconductor package of claim 7, wherein the AMC comprises:
a first layer with a first periodic pattern of metal elements;
a second layer with a second periodic pattern of metal elements; and
a dielectric layer disposed between the first layer and the second layer of the AMC.

9. The semiconductor package of claim 1, wherein the dipole antenna is configured to operate in a frequency range of 57-64 GHz with a return loss better than −14 dB.

10. A millimeter-wave device comprising:
a flat no-leads semiconductor package comprising:
an interconnect having leads and a ground plane;
a semiconductor die mounted on the ground plane of the interconnect;
a dipole antenna formed from the ground plane of the interconnect and electrically connected to the semiconductor die;
a plurality of wire bonds circumscribing the dipole antenna to form an RF (radio frequency) shielding cavity; and
a mold compound encapsulating the dipole antenna, the die and a portion of the interconnect; and
a PCB (printed circuit board) comprising an AMC (artificial magnetic conductor) structure positioned below the dipole antenna.

11. The millimeter-wave device of claim 10, wherein a portion of the wire bonds are crossed.

12. The millimeter-wave device of claim 10, wherein the dipole antenna and the AMC structure are separated by less than one-quarter wavelength of a center frequency of the dipole antenna.

13. The millimeter-wave device of claim 10, wherein the dipole antenna comprises a set of dipole antennas arranged in a two-transmitter, two-receiver configuration.

14. The millimeter-wave device of claim 13, wherein the wire bonds provide isolation between adjacent dipole antennas of the set of dipole antennas.

15. The millimeter-wave device of claim 13, wherein at least two of the dipole antennas of the set of dipole antennas are separated by approximately one-half of a wavelength of a center frequency of the at least two of the dipole antennas.

16. The millimeter-wave device of claim 10, wherein the dipole antenna operates in a frequency range of 57-64 GHz with a return loss better than −14 dB (decibels).

17. The millimeter-wave device of claim 10, wherein the AMC structure further comprises:
a first layer with a first periodic pattern of metal elements;
a second layer with a second periodic pattern of metal elements; and
a dielectric layer disposed between the first layer and the second layer of the AMC.

18. A method of fabricating a semiconductor package, comprising:
mounting a semiconductor die on a ground plane of a flat no-leads interconnect;
forming a dipole antenna from the ground plane of the flat no-leads interconnect;
placing wire bonds circumscribing the dipole antenna to create a cavity for shielding the dipole antenna; and
encapsulating the semiconductor die, the dipole antenna, the wire bonds and a portion of the interconnect in a mold compound.

19. The method of claim 18, wherein the dipole antenna comprises a set of dipole antennas.

20. The method of claim 18, wherein the dipole antenna is spaced from a bottom surface of the semiconductor package by less than one-quarter of a wavelength of a center frequency of the dipole antenna.
